(19) United States
(12) Patent Application Publication
(10) Pub. No.: US 2010/0019186 A1
(43) Pub. Date: Jan. 28, 2010

(54) ENGINE VALVE ASSEMBLY WITH VALVE CAN MOUNTABLE TO AN ENGINE COVER

(75) Inventors: Robert D. Keller, Davisburg, MI (US); Robert J. Boychuk, Sterling Heights, MI (US)

Correspondence Address: QUINN LAW GROUP, PLLC, 39555 ORCHARD HILL PLACE, SUITE # 520, NOVI, MI, 48375, US

(73) Assignee: EATON CORPORATION, Cleveland, OH (US)

(21) Appl. No.: 12/248,077

(22) Filed: Oct. 9, 2008

Related U.S. Application Data
(60) Provisional application No. 61/083,663, filed on Jul. 25, 2008.

(51) Int. Cl. F16K 27/00

(52) U.S. Cl. 251/366

(57) ABSTRACT

An engine valve assembly is provided with a valve housing configured to promote easy fastening and removal of the valve assembly from an engine cover. The housing has a first wall and a side wall that extends therefrom to partially define an interior cavity with a cavity opening opposite the first wall. In some embodiments, the first wall has a generally teardrop-shaped surface. The first wall has a valve opening and a fastener opening that is spaced from and aligned with the valve opening along the first wall. A valve body is supported by the valve housing at least partially within the interior cavity, and may be press-fit therein. The valve housing mounts to the engine cover with the fastener inserted through the fastener opening to extend through the interior cavity and fasten to the engine cover, with the valve body extending into the engine cover.

### CROSS-REFERENCE TO RELATED APPLICATIONS

This application claims the benefit of U.S. Provisional Application 61/083,663, filed Jul. 25, 2008, which is hereby incorporated by reference in its entirety.

### TECHNICAL FIELD

The invention relates to an engine valve assembly mountable to an engine cover.

### BACKGROUND OF THE INVENTION

An electro-hydraulic system of valves typically controls inlet and exhaust from engine cylinders, as well as the amount of valve lift, in a modern automotive engine. Multiple valves are typically mounted to an engine cam cover. The cover is often of complex topography and must accommodate a variety of other components. An electro-hydraulic valve for an engine that fastens to the cam cover without interference from other components and in an ergonomic manner is desired.

### SUMMARY OF THE INVENTION

An engine valve assembly is provided with a valve housing, also referred to as a can or cover, that is configured to promote easy access to a fastener used for fastening and removing the valve assembly from an engine cover. The valve assembly may be a solenoid-type oil control valve assembly or other type of engine valve that mounts to an engine cover, and the engine cover may be a cam cover, or any portion of an engine block. The can has a first wall and a side wall that extends therefrom to partially define an interior cavity with a cavity opening opposite the first wall. In some embodiments, the first wall has a generally teardrop-shaped surface, as described in detail herein. The first wall has a valve opening as well as a fastener opening that is spaced from and aligned with the valve opening along the first wall. A valve body is supported by the valve housing at least partially within the interior cavity, and may be press-fit therein, in alignment with the valve opening. The valve housing is configured to mount to the engine cover with the fastener inserted through the fastener opening to extend through the interior cavity and fasten to the engine cover, with the valve body extending into the engine cover. Separation of the fastener opening from the face of the engine cover by the side wall makes the fastener more accessible for insertion and removal, especially if the engine cover has unusual surface geometry or adjacent components that would make access to a fastener opening closer to the engine cover surface more difficult. Cans that have a teardrop-shaped surface may more easily fit in available packaging space on the engine cover due to the tapered nature of the teardrop shape.

Some embodiments of the can have an opening in the sidewall, also referred to as a window, through which an electrical connector connects with a valve coil and extends for easy access with a mating connector. The window may be offered in different positions on the sidewall for different embodiments, depending on specific application needs. Different electrical connectors may be connected on cans with like windows, as the window may permit connectors of various orientations.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1A is a schematic perspective illustration of a first embodiment of an engine oil control valve assembly having a first embodiment of a valve can;

FIG. 1B is a schematic top view of the valve can of FIG. 1A;

FIG. 2 is a schematic cross-sectional illustration of the valve assembly with valve can of FIG. 1, taken at the lines 2-2 of FIG. 1A;

FIG. 3 is a schematic cross-sectional illustration of the valve assembly with valve can of FIG. 1A, taken at the lines 3-3 of FIG. 1A and shown with a fastener mounting the valve to an engine cam cover;

FIG. 4 is a schematic perspective illustration of an alternative valve can for use with the valve body of FIGS. 1A-3, including a window for electrical connector access;

FIG. 5 is schematic perspective illustration of a second embodiment of an engine oil control valve assembly with the can of FIG. 4 and a first embodiment of an electrical connector extending laterally through the window;

FIG. 6 is a schematic perspective illustration of a third embodiment of an engine oil control valve assembly with the can of FIG. 4 and a second embodiment of an electrical connector extending at a skewed angle through the window;

FIG. 7 is a schematic perspective illustration of a fourth embodiment of an engine oil control valve assembly with the can of FIG. 4 and a third embodiment of an electrical connector extending through the window and vertically;

FIG. 8 is a schematic perspective illustration of a fifth embodiment of an engine oil control valve assembly with a third embodiment of a can and a fourth embodiment of an electrical connector extending through the window and vertically;

FIG. 9 is a schematic perspective illustration of a sixth embodiment of an engine oil control valve assembly with a fourth embodiment of a can and a fifth embodiment of an electrical connector extending through the window and vertically; and

FIG. 10 is a schematic perspective illustration in fragmentary view of the valve assembly of FIG. 5 mounted to a second embodiment of an engine cam cover.

### DESCRIPTION OF THE PREFERRED EMBODIMENTS

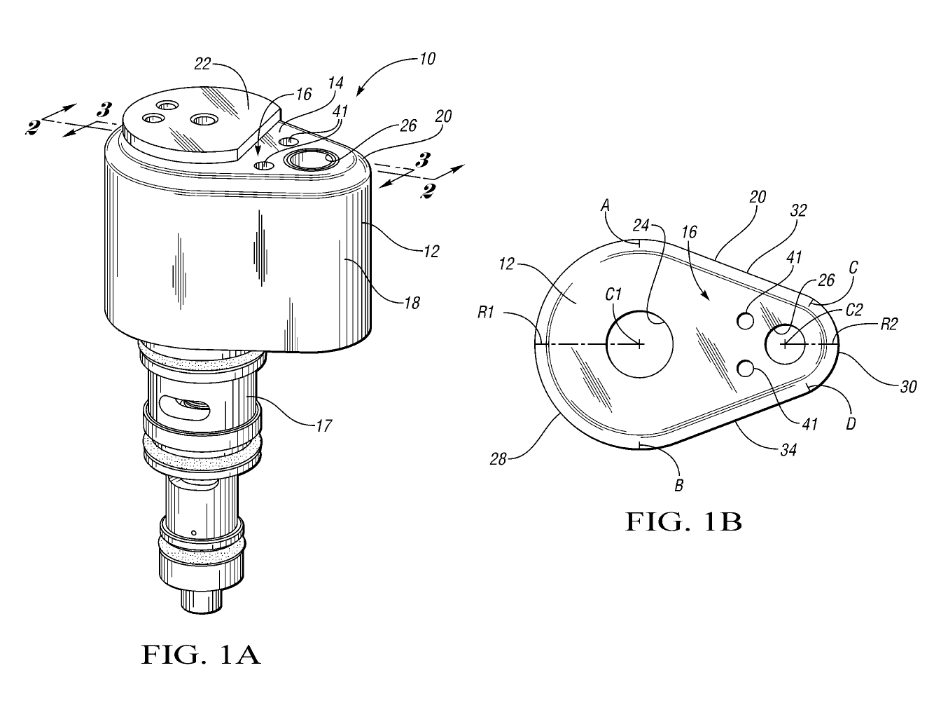

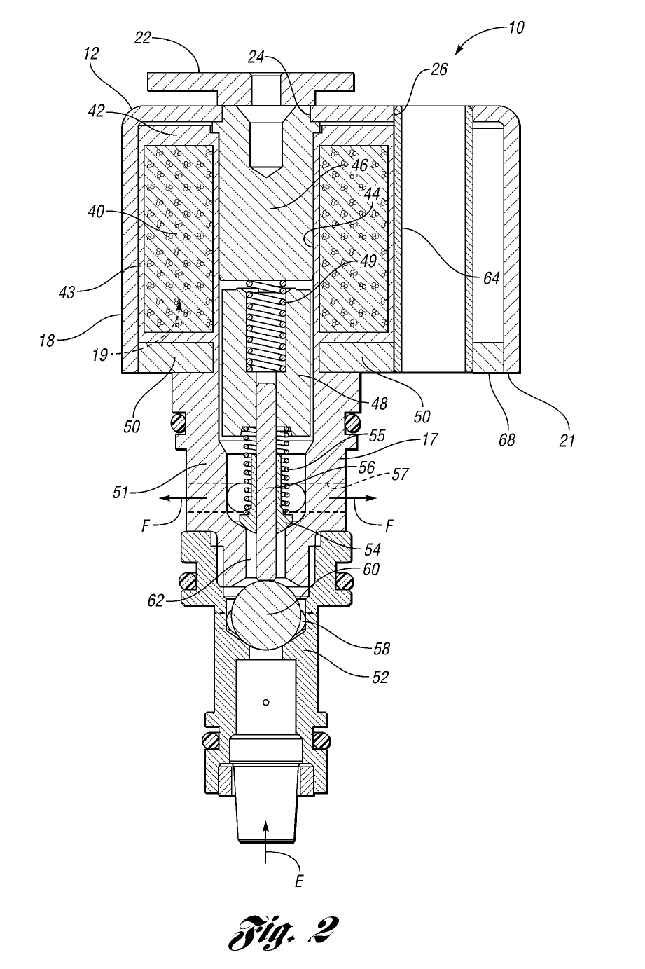

Referring to the drawings, wherein like reference numbers refer to like components, FIG. 1A shows an engine oil control valve assembly 10 including a valve housing 12, also referred to as a can or cap, with a first wall 14 having a generally teardrop-shaped face 16. A valve body 17 extends from the can 12. The valve can 12 includes a side wall 18 extending from a periphery 20 of the first wall 14, generally perpendicularly to the face 16. The valve body 17 is press-fit into an interior cavity 19 formed by the face 16 and side wall 18 (shown in FIG. 2), through a cavity opening at terminal end 21 of the side wall 18. The periphery 20 is shown most clearly in FIG. 1B. A pole piece cover 22 shown in FIG. 1A is removed in FIG. 1B to reveal a valve opening 24 in the first wall 14. A fastener opening 26 is displaced laterally from the valve opening 24 along the face 16.

Referring to FIG. 1B, the teardrop-shaped face 16 is determined by the periphery 20, which has a first portion 28 extending from point A to point B that is characterized by a first radius R1 centered at a center C1 of the valve opening 24. The periphery 20 also has a second portion 30 extending from point C to point D that is characterized by a second radius R2 centered at a center C2 of the fastener opening 26. A third portion 32 of the periphery connects the first portion 28 with the second portion 30, as does an opposite fourth portion 34.

Although the teardrop-shaped face 16 is established by the periphery 20 described above, other teardrop-shaped faces as well as faces that are not teardrop-shaped and are established by different peripheries, are within the scope of the claimed invention. In general, a “teardrop-shaped” face is a generally planar face with a periphery that generally tapers from a larger rounded portion to a smaller rounded portion.

As illustrated in FIGS. 2 and 3 and as further described below, the can 12 of the engine oil control valve assembly 10 enables ease in fastening to an engine cover, and more specifically, a cam cover 37 (shown in FIG. 3) via a threaded fastener 38. As used herein, an engine cover may be a cam cover. Referring to FIG. 2, the engine oil control valve assembly 10 includes an electrical coil 40 surrounded by a coil support portion 42 (also referred to as a bobbin) of the valve body 17 and encapsulated in a coil cover 43. The valve body 17 defines an armature chamber 44 in which a pole piece 46 is press-fit. An armature 48 is movable in the armature chamber 44 in response to energizing of the coil 40. A main spring 49 biases the armature 48 away from the pole piece. A flux collector 50 (also referred to as a flux bracket) is supported adjacent the coil 40 and armature 48 by a base portion 51 of the valve body 17. Electrical wiring for energizing of the coil 40 may be connected with the coil 40 through wiring openings 41, shown in FIGS. 1A and 1B. Alternatively, an electrical connector may be mounted in a fixed position to the side wall 18, accessing the coil 40 through the side wall 18.

The pole piece 46, valve can 12, coil 40, armature 48 and flux collector 50 form an electromagnet. Lines of flux are created in an air gap between the pole piece 46 and the armature 48 when the coil 40 is energized by an electric source (such as a battery, not shown). The armature 48 moves in response to the flux.

The valve body 17 includes an extension portion 52 open to receive inlet flow from an oil pump (not shown) at a supply pressure, indicated as arrow E. The oil control valve assembly 10 is a normally closed valve, with a poppet valve 54 movable along a rod 56 fit to the armature 48. A regulator spring 55 biases the poppet valve 54 to a closed position. The poppet valve 54 is thus biased to close an exhaust flow path 57, with exhaust flow indicated as arrow F, when the coil 40 is not energized. This prevents exhaust venting of oil in control port 58 that flows at a control pressure to an engine valve latching mechanism (not shown). When the coil 40 is not energized and the control pressure is too high, the biasing force of the spring 55 will be overcome, lifting the poppet valve 54, to allow oil in the control port 58 to vent through channel 62 to exhaust flow path 57, until control pressure is adequately decreased. Alternatively, when control pressure is too low and the coil 40 is not energized, the biasing force of main spring 49 will be overcome by force of fluid at supply pressure, lifting the armature 48 and rod 56 and allowing the ball 60 to move upward so that fluid at supply pressure E flows to the control port 58 until control pressure is adequately increased. When the coil is energized, the armature 48 and rod 56 move upward, permitting fluid flow at supply pressure E to control port 58.

The base portion 51, coil support portion 42, extension portion 52, and can 12 may be made integral or made unitary with one another by casting, molding, or other processes.

A tubular support member 64 is connected to the can 12 by a press-fit, welding, bonding or otherwise at the fastener opening 26. The tubular support member 64 is a material sufficient to bear torque loading when the threaded fastener 38 is driven through the support member 64 to a threaded opening 66 (see FIG. 3) in the cam cover 37. For example, the can 12 and the support member 64 may both be 1010 steel. Although not shown in FIGS. 2 and 3, the support member 64 may be thicker than the face 16 and side wall 18 of the can 12 if considered necessary to withstand the expected torque loading. A plug insert 68 surrounds the support member 64 to partially fill the opening of the can 12 at the terminal end of the side wall 18 between the tubular support member 64 and the side wall 18.

Referring to FIG. 3, with the oil control valve assembly 10 mounted to the cam cover 37 by threaded fastener 38, the valve body 17 extends into a valve bore 70 in the cam cover 38. Seals 72A, 72B and 72C seal the valve body 17 to the bore 70 and the can 12 encloses the bore 70 at the cam cover surface 74.

A head 76 of the fastener 38 rests on the face 16 of the can 12 when the fastener 38 is adequately tightened to secure the valve assembly 10 to the cam cover 37. The pole piece cover 22 is removed in FIG. 3, but fits adjacent the secured fastener head 76, as is apparent from FIG. 2.

In various engine embodiments, the cam cover 37 in the vicinity of the valve bore 70 may be at a severe angle to horizontal and may also have many additional surrounding components that limit access to the area above the valve bore 70 and threaded opening 66. Especially in such situations, because the fastener head 76 rests on the face 16, elevated from the cam cover surface 74 by the side wall 18, the fastener opening 26 is more accessible to tools used to torque the fastener 38 than, for example, a fastener opening much closer to the surface 74. Additionally, the teardrop-shape of the face 16 allows the fastener 38 and threaded opening 66 to align with one another in a tight packaging space, with close surrounding cam cover surface geometry and/or surrounding components.

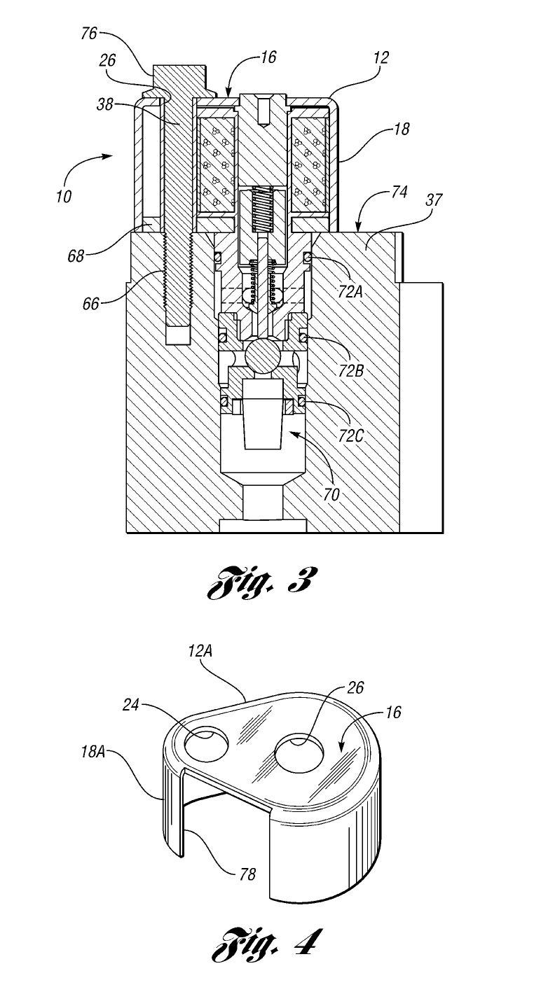

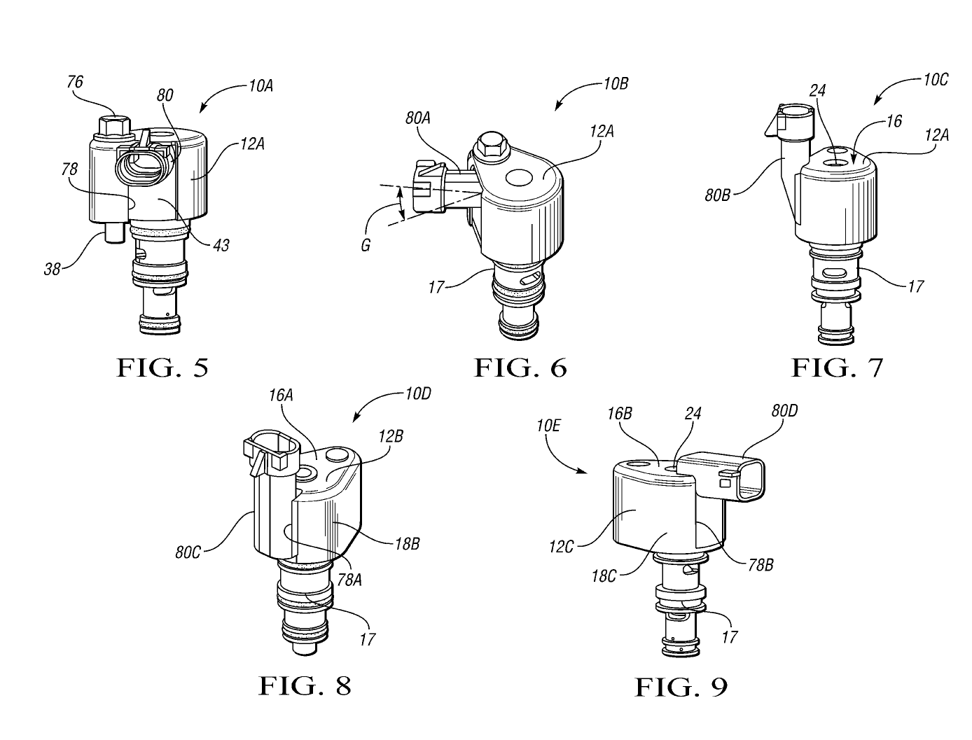

Referring to FIG. 4, another embodiment of a valve housing or can 12A is shown that has an opening, referred to herein as a window 78 in the sidewall 18A. All other features of the can 12A are identical to those of can 12 of FIG. 1, and are referred to with like reference numbers. The window 78 allows an electrical connector connected with the coil of the valve body to extend from the can 12A in a variety of possible directions, allowing connection with a mating connector in a manner that is not impeded by surrounding components or surface geometry of the cam cover. For example, FIG. 5 shows oil control valve assembly 10A, alike in every aspect to oil control valve assembly 10 of FIG. 1 with the exception of can 12A. The window 78 allows connector 80 to attach to valve body 17 in a direction substantially perpendicular to the plane of window 78. The coil cover 43 is visible through window 78.

FIG. 6 shows oil control valve assembly 10B with can 12A, valve body 17 and connector 80A. Oil control valve assembly 10B is alike in every aspect to oil control valve assembly 10A, with the exception of the positioning of connector 80A. The window 78 allows the connector 80A to extend at an angle G from a line perpendicular to the plane of the window 78. Thus, a connector that mates with connector 80A is installed non-perpendicularly to the window 78.

FIG. 7 shows valve assembly 10C with can 12A, valve body 17 and connector 80B. Oil control valve assembly 10C is alike in every aspect to oil control valve assemblies 10A and 10B, with the exception of the positioning of connector 80B. Connector 80B connects with the coil 40 shown in FIG. 2 through the window 78 and extends beyond the face 16 to allow connection to a mating connector in a direction substantially parallel with the valve opening 24.

FIG. 8 shows oil control valve assembly 10D with can 12B, valve body 17 and connector 80C. Oil control valve assembly 10D is alike in every aspect to oil control valve assembly 10A, with the exception of window 78A being in a different position on sidewall 18B to allow the positioning of connector 80C, as shown, and window 78A extending into a portion of face 16A.

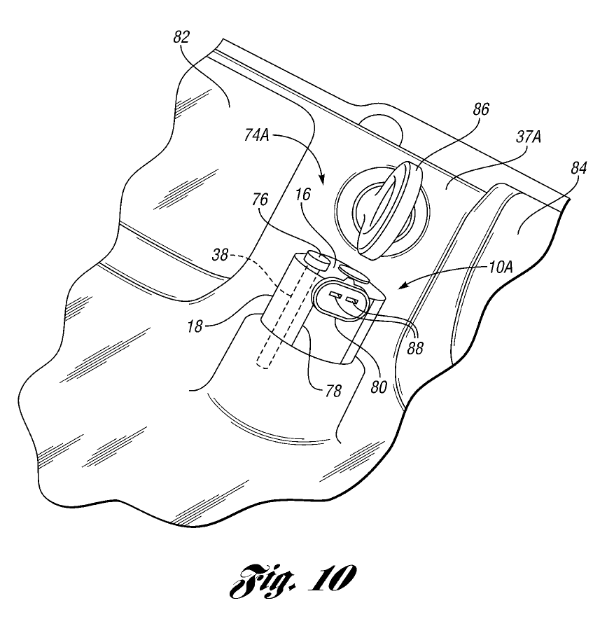

FIG. 9 shows oil control valve assembly 10E with a can 12C, valve body 17 and connector 80D positioned in connection with the coil 40 of FIG. 2 through window 78B of side wall 18C, with connector 80D in a different orientation than connector 80C. A larger portion of window 78B extends into face 16B so that a portion of connector 80D rests above face 16B. Connector 80D is positioned for connection with a mating connector in a direction substantially perpendicular to the valve opening 24.

FIG. 10 shows oil control valve assembly 10A of FIG. 5 mounted to cam cover 37A by fastener 38. Fastener head 76 is accessible for insertion and removal of the fastener 38 regardless of the limited access space due to uneven surface geometry of face 74 and surrounding components 82, 84 and dipstick 86. Elevation of the fastener head 76 above the surface 74A by sidewall 18 promotes easy access. As in FIG. 5, the connector 80 extends through window 78 in a direction substantially perpendicular to the fastener 38. Thus, the fastener 76 is inserted in a different direction than a direction by which the mating connector is connected with terminals 88 of connector 80.

While the best modes for carrying out the invention have been described in detail, those familiar with the art to which this invention relates will recognize various alternative designs and embodiments for practicing the invention within the scope of the appended claims.

1. An engine valve assembly for mounting to an engine cover with a fastener, comprising:
a valve housing having a first wall and a side wall extending from the first wall to partially define an interior cavity with a cavity opening opposite the first wall; wherein the first wall has a valve opening and a fastener opening spaced from the valve opening and aligned with the valve opening along the first wall; and
a valve body supported by the valve housing at least partially within the interior cavity and aligned with the valve opening;
wherein the valve housing is configured to mount to the engine cover with the fastener inserted through the fastener opening to extend through the interior cavity and fasten to the engine cover with the valve body extending into the engine cover.

2. The engine valve assembly of claim 1, wherein the first wall has a generally teardrop shape.

3. The engine valve assembly of claim 1, wherein the side wall has a side opening therein; and further comprising:
an electrical coil supported by the valve body substantially within the interior cavity; and
an electrical connector operatively connected with the electrical coil and extending through the side opening.

4. The engine valve assembly of claim 3, wherein the electrical connector extends through the side opening and is adapted for connection with a matable connector in a direction substantially non-perpendicular to the side opening.

5. The engine valve assembly of claim 3, wherein the electrical connector extends through the side opening and is adapted for connection with a matable connector in a direction substantially perpendicular to the valve opening.

6. The engine valve assembly of claim 1, further comprising:
a tubular support member extending from the fastener opening toward the cavity opening and configured to bear torque loading on the fastener when the fastener extends through the fastener opening and the tubular support member.

7. The engine valve assembly of claim 1, further comprising:
a pole piece operatively connected with the valve body and extending through the valve opening.

8. The engine valve assembly of claim 1, wherein the valve body is press-fit to the valve housing within the interior cavity.

9. An oil control valve assembly for an engine having a cam cover, comprising:
a valve body;
a valve can with a generally teardrop-shaped face and a side wall extending therefrom to define an interior cavity with an open terminal end opposite the face and separated therefrom by the sidewall; wherein the face has a valve opening and a fastener opening; wherein the valve can is mountable to the cam cover by a fastener extending through the fastener opening with a fastener head resting on the face and with the valve body supported at the valve opening; the fastener head thereby being displaced from the cam cover by the sidewall to promote ease of access to the fastener head.

10. The oil control valve of claim 9, wherein the teardrop-shaped face is characterized by a periphery with a first radial segment of a first radius and a second radial segment of a second radius smaller than the first radius; wherein the valve opening is generally centered at a first center of the first radial segment and the fastener opening is generally centered at a second center of the second radial segment.

11. The oil control valve of claim 9, further comprising:
an electrical coil at least partially within the valve can; and
an electrical connector operatively connected with the electrical coil;
wherein the side wall has an opening permitting the electrical connector to connect with the electrical coil in different directions.

12. An engine valve assembly for mounting to an engine cover with a fastener, comprising:
a valve housing having a first wall and a side wall extending from the first wall to partially define an interior cavity with a cavity opening opposite the first wall; wherein the first wall has a valve opening and a fastener opening spaced from the valve opening and aligned with the valve opening along the first wall; wherein the side wall has a side opening therein;
a valve body supported by the valve housing at least partially within the interior cavity and aligned with the valve opening;
an electrical coil supported by the valve body substantially within the interior cavity;
an electrical connector operatively connected with the electrical coil and extending through the side opening;
a tubular support member extending from the fastener opening toward the cavity opening and configured to bear torque loading on the fastener when the fastener extends through the fastener opening and the tubular support member; and
a pole piece operatively connected with the valve body and extending through the valve opening;
wherein the valve housing is configured to mount to the engine cover with the fastener inserted through the fastener opening to extend through the interior cavity and fasten to the engine cover with the valve body extending into the engine cover.

13. The engine valve assembly of claim 12, wherein the first wall has a generally teardrop shape.

14. The engine valve assembly of claim 12, wherein the electrical connector extends through the side opening and is adapted for connection with a matable connector in a direction substantially non-perpendicular to the side opening.

15. The engine valve assembly of claim 12, wherein the electrical connector extends through the side opening and is adapted for connection with a matable connector in a direction substantially perpendicular to the valve opening.

16. The engine valve assembly of claim 12, wherein the valve body is press-fit to the valve housing within the interior cavity.
